(19) United States
(12) Patent Application Publication
(10) Pub. No.: US 2008/0131766 A1
(43) Pub. Date: Jun. 5, 2008

(54) Flat Battery

(76) Inventors: Masahiko Yoshida, Osaka (JP); Toshiya Kuwamura, Nara (JP)

Correspondence Address: WENDEROTH, LIND & PONACK L.L.P., 2033 K. STREET, NW, SUITE 800, WASHINGTON, DC, 20006, US

(21) Appl. No.: 11/793,017

(22) PCT Filed: Dec. 14, 2006
(86) PCT No.: PCT/JP2006/024945

§ 371 Date: Jun. 14, 2007

(30) Foreign Application Priority Data
Dec. 19, 2005 (JP) 2005-364612

(51) Int. Cl. H01M 6/02

(52) U.S. Cl. 429/162

(57) ABSTRACT

A flat battery includes a positive electrode having voids therein, a negative electrode, a separator, an electrolyte solution, and a sealed case. The negative electrode is composed of a metal including an alkali metal and is disposed facing the positive electrode. The separator is interposed between the positive electrode and the negative electrode and electrically insulates the positive electrode from the negative electrode so that they are not brought into direct contact with each other. The electrolyte solution is impregnated into the separator and is interposed between the positive and negative electrodes. The sealed case contains the positive and negative electrodes, the separator, and the electrolyte solution. A volume of the electrolyte solution is larger than a space volume at the side of the positive electrode when space formed in the sealed case is divided by a plane dividing into two sections at the middle in the thickness direction thereof.

### TECHNICAL FIELD

The present invention relates to a flat battery. In particular, it relates to a flat battery used in an environment in which a centrifugal force is applied, for example, when the battery is attached to a rotor.

### BACKGROUND ART

In a general chemical battery, an electrochemical reaction generating electrical energy proceeds by ionic conduction in an electrolyte that is present between a positive electrode and a negative electrode. In general, a liquid electrolyte (electrolyte solution) is present in a state in which it is impregnated into a separator interposed between the positive and negative electrodes, and contributes to oxidation/reduction reactions between the positive and negative electrodes. An electrolyte solution can be roughly classified into an aqueous solution and an organic solution. Furthermore, recently, batteries using a solid electrolyte such as a polymer electrolyte have been developed.

Among these batteries, a flat battery is often used in a real-time clock or a memory backup power supply of equipment, consumer appliances such as an electronic calculator and a watch, or the like. Although vibration or shock is applied to equipment on which a battery is mounted, such equipment is basically used in a stationary state in many cases. Thus, in most cases, batteries are used in stationary equipment or portable equipment. In those cases, vibration may be applied to the battery, but a centrifugal force or acceleration is hardly applied. Thus, general battery designs do not consider the operation in an environment in which a centrifugal force is applied.

In a stationary state, an electrolyte solution is present in space in a positive electrode, however, the electrolyte solution does not infiltrate into a fine hole portion or a portion with high packing density of the positive electrode material. Therefore, an electrolyte solution is present on the interface between the positive and negative electrodes and participates in a discharge reaction without difficulties.

However, when a battery is mounted on a device to which a centrifugal force is applied, the electrolyte solution in the battery flows due to the centrifugal force. As a result, the electrolyte solution that should be present on the surfaces facing the positive and negative electrodes so as to contribute to oxidation/reduction reactions may flow into voids in active materials or gaps between components. Therefore, in particular, when a large amount of electric current is needed, or in a low temperature environment, the discharge performance of the battery is significantly reduced.

For example, a battery is also used for operating a device that is configured to measure the air pressure of a tire of a vehicle during the vehicle is running. To such a battery, a centrifugal force caused by the rotation of the tire is applied. When the vehicle reaches a cruising speed, 200 G or more of centrifugal force is applied to the equipment and the battery. Consequently, an electrolyte solution is unevenly distributed and the discharge property is lowered as mentioned above.

As a method for stably discharging in an environment in which a centrifugal force is applied, a method for specifying the direction in which a battery is disposed on a rotor is described in, for example, Patent document 1. According to this method, an electrolyte solution is present on the surfaces facing the positive and negative electrodes, and a battery normally operates even in an environment in which a centrifugal force is applied.

During vehicle operation, by friction between a tire and a road surface, friction at the time of braking, or the like, the temperature inside the tire of the vehicle becomes higher than the outside air temperature. For example, at the time of quick braking, the temperature may become 100° C. or higher. Therefore, for such an application, an organic electrolyte solution battery, for example, a lithium primary battery, that can be used at high temperatures is used. Since a negative electrode of the lithium primary battery is made of metal and does not have space therein, if a centrifugal force is applied in the direction toward the negative electrode, an electrolyte solution is present on the surface of the negative electrode, that is, on the interface between the negative and positive electrodes, thus enabling normal discharge.

Furthermore, in the discharge reaction, it is important that a sufficient amount of the electrolyte solution is present in a separator. However, the electrolyte solution is gradually decomposed to generate gas in the battery. With this gas, a position of the electrolyte solution in the battery or contact between components of the battery may be unstable. In order to response such situations, a method for reducing a pressure inside the battery is described in Patent document 2.

In general, when an organic electrolyte solution battery is stored for a long time or in a high temperature and high humidity environment, the organic electrolyte solution is gradually decomposed to generate hydrogen, methane, or the like. When theses gases are accumulated in a battery, the internal pressure is increased. The increase of the internal pressure causes deformation of the battery or reduction of the leakproof property. Therefore, in order to relax the increase of the internal pressure, space including only gases without including components constituting the battery or an electrolyte solution is provided in the battery. In this space, air that has been present when the battery is sealed, or an inert gas substituting air is present. Therefore, the electrolyte solution is filled in the battery in an amount that secures necessary space. This is an amount that is present in a separator on the interface between the positive and negative electrodes and is sufficient for carrying out a discharge reaction under the condition in which a centrifugal force is not applied. Therefore, when the battery is used in equipment in which no centrifugal force is applied, it is not necessary to specify the amount of an electrolyte solution and a volume of the space in the battery. Even when the amount of an electrolyte solution is increased, the discharge property of the battery is not improved and the leakproof property may be lowered. Therefore, a smaller amount of an electrolyte solution is used in conventional batteries.

In a conventional organic electrolyte solution battery, as described in Patent document 1, normal discharge cannot be carried out without specifying the direction in which a battery is set on a rotor. However, in some cases, it may be difficult to set a battery in the specified direction because of design of a circuit board of equipment or an arrangement of components on the board. For example, in the case of an air-pressure measurement instrument placed inside of a tire, the width of a tire wheel is smaller than the diameter of a battery, the battery is set on the tire wheel lengthwise or obliquely. That is to say, it is difficult to position the negative electrode of the battery at the outer side in the direction of the centrifugal force as described in Patent document 1. Thus, the method in Patent document 1 cannot be sometimes carried out.

Patent document 1: Japanese Patent Unexamined Publication No. 11-242948

Patent document 2: Japanese Patent Unexamined Publication No. 5-182649

### SUMMARY OF THE INVENTION

The present invention relates to a battery whose discharge performance is not deteriorated even in the case where a battery is disposed on a device to which a centrifugal force is applied in the direction in which discharge is difficult in the case of a conventional battery. A flat battery of the present invention includes a positive electrode having voids therein, a negative electrode, a separator, an electrolyte solution, and a sealed case. The negative electrode is composed of a metal including an alkali metal and is disposed facing the positive electrode. The separator is interposed between the positive electrode and the negative electrode and electrically insulates the positive electrode from the negative electrode so that they are not brought into direct contact with each other. The electrolyte solution is interposed between the positive electrode and the negative electrode in a state in which the separator is impregnated with the electrolyte solution. The sealed case contains the positive electrode, the negative electrode, the separator and the electrolyte solution. The volume of the electrolyte solution is larger than the space volume at the side of the positive electrode when space formed in the sealed case is divided by a plane dividing the separator into two sections at the middle in the thickness direction thereof. When the battery is designed in this way, regardless of the direction in which the battery is set with respect to the centrifugal force direction, the electrolyte solution is present on the interface between the positive and negative electrodes. That is to say, by maintaining the amount of an electrolyte solution and the space volume at the side of the positive electrode as specified in the present invention, even in an environment in which a centrifugal force is applied, a separator is always impregnated, and the discharge reaction between the positive and negative electrodes can be carried out. Therefore, the flat battery of the present invention can carry out stable discharge regardless of an angle at which the battery is attached to a rotor or a stationary angle.

### BRIEF DESCRIPTION OF THE DRAWINGS

FIG. 1 is a sectional view showing a flat battery in accordance with an exemplary embodiment of the present invention.

FIG. 2 is a perspective view showing a direction of the centrifugal force applied to the flat battery on a rotor.

FIG. 3 is a front view showing a direction of the centrifugal force applied to the flat battery on the rotor.

FIG. 4 is an enlarged view showing an angle at which the flat battery is attached to the rotor.

### REFERENCE MARKS IN THE DRAWINGS

1 sealing plate
2 negative electrode
3 positive electrode
4 separator
5 positive electrode case
6 gasket
8 plane dividing separator into two sections in the thickness direction
9 direction of central axis from center of positive electrode to center of negative electrode (normal line)
10 battery
11 terminal
12 rotor
13 rotation axis

### DETAILED DESCRIPTION OF THE PREFERRED EMBODIMENT

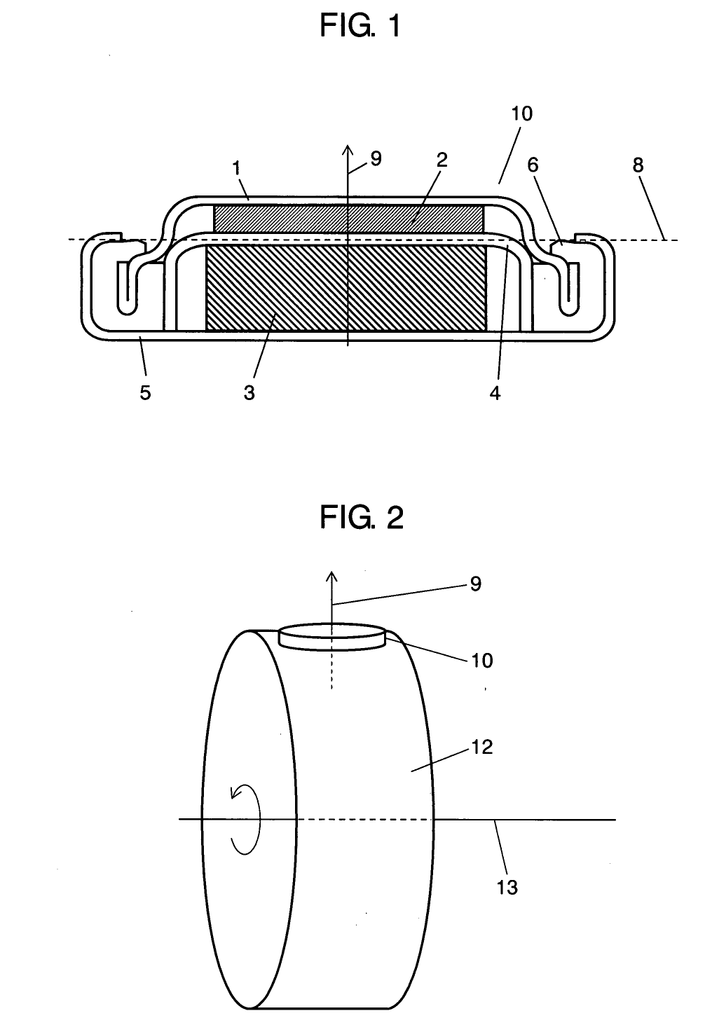

FIG. 1 is a sectional view showing a flat battery in accordance with an exemplary embodiment of the present invention. Flat battery (hereinafter, referred to as battery) 10 includes positive electrode 3 having voids therein, negative electrode 2, separator 4, an electrolyte solution (not shown), positive electrode case (hereinafter, referred to as case) 5, and sealing plate 1. Negative electrode 2 is composed of a non-pored metal including an alkali metal and is disposed facing positive electrode 3. That is to say, negative electrode 2 is made of an alkali metal or an alkali metal alloy. Separator 4 is interposed between positive electrode 3 and negative electrode 2 and electrically insulates positive electrode 3 from negative electrode 2 so that they are not brought into direct contact with each other. The electrolyte solution is interposed between positive electrode 3 and negative electrode 2 in a state in which separator 4 is impregnated with the electrolyte solution. Case 5 and sealing plate 1 are assembled with each other via gasket 6 so as to constitute a sealed case containing positive electrode 3, negative electrode 2, separator 4, and the electrolyte solution. The volume of the electrolyte solution is larger than the space volume at the side of positive electrode 3 when the space formed in the sealed case is divided by plane 8 dividing separator 4 into two sections at the middle in the thickness direction thereof. That is to say, the volume of the electrolyte solution filled in battery 10 is larger than a space volume obtained by subtracting a real volume of all components and materials that are present in battery 10 at the side of positive electrode 3 from the entire space volume in battery 10 at the side of positive electrode 3.

When such an amount of an electrolyte solution is filled, the voids of battery 10 and separator 4 are filled with the electrolyte solution. Consequently, battery 10 always shows a stable discharge property. That is to say, no matter how battery 10 is disposed in an environment in which a centrifugal force is applied, discharge can be carried out normally. Furthermore, with respect to the deterioration of the leakproof property that may be caused by specifying the amount of an electrolyte solution, a performance without having practical problems can be secured by specifying the filing proportion of positive electrode 3.

When a space volume obtained by excluding a real volume of all components and materials that are present in battery 10 from space in battery 10 is divided by plane 8 dividing separator 4 into two sections at the middle in the thickness direction, and the space volume at the side of positive electrode 3 is larger than the volume of an electrolyte solution, the electrolyte solution is not sufficiently present on separator 4 depending upon the direction in which a centrifugal force is applied. Therefore, this is not preferable because discharge is not normally carried out.

When the filling amount of positive electrode 3 and the amount of an electrolyte solution are designed as in this exemplary embodiment, the space in battery 10 is reduced. Therefore, when gas is generated due to decomposition of the electrolyte solution and the pressure inside battery 10 is increased, solution leakage may occur earlier than general batteries. Therefore, it is preferable that the pressure inside battery 10 is specified to be a reduced pressure. Specifically, it is preferable that the pressure inside battery 10 is not more than one atmospheric pressure. Thus, the effect of gas generated by decomposition of the electrolyte solution during storage is suppressed and the leakproof property can be well maintained. Regardless of attaching method employed in the environment in which a centrifugal force is applied, stable discharge can be always carried out.

In general, when sealing is carried out under atmospheric pressure, case 5 and sealing plate 1 are assembled with each other via gasket 6, which is compressed to a predetermined height. Therefore, the pressure inside the battery becomes higher than the atmospheric pressure. In this exemplary embodiment, it is preferable that the pressure inside battery 10, that is, a total amount of air inside battery 10 is reduced at the time of manufacture. In this way, by reducing the pressure inside battery 10 at the time of assembly, the pressure when gas is accumulated in battery 10 is relaxed. Even in the case where the amount of an electrolyte solution and the real space volume at the side of the positive electrode are adjusted, an excellent leakproof property can be maintained. It is preferable that the pressure inside battery 10 at the time of assembly is maintained to be not less than 0.4 atmospheric pressures in order to avoid that a concentration of a supporting salt is remarkably changed due to vaporization of a solvent constituting the electrolyte solution.

Furthermore, also by filling the outside of battery 10 with resin (not shown) so as to enhance the strength of the exterior of battery 10, it is similarly possible to maintain an excellent leakproof property.

Hereinafter, specific examples are described. Firstly, a producing procedure of a test battery of sample A is described.

Positive electrode 3 includes manganese dioxide as an active material, carbon as a conductive material, a dispersion solution of polytetrafluoroethylene (PTFE) as a binder in a solid ratio of 100:7:1. This mixture is kneaded and dried so as to be molded into a cylindrical shape having a diameter of 18.5 mm and a thickness of 0.6 mm. This product is dried again and used as positive electrode 3.

As negative electrode 2, 0.08 g of metallic lithium is compressed to sealing plate 1. Sealing plate 1 is produced by shaping a stainless plate having a thickness of 0.2 mm.

Positive electrode 3 produced as mentioned above is inserted into case 5 and separator 4 is disposed on the upper surface of positive electrode 3. For separator 4, a polypropylene non-woven fabric is used. Furthermore, 320 μl of an electrolyte solution obtained by dissolving 1 mol/l of lithium perchlorate in a mixture solvent containing propylene carbonate and dimethoxyethane in the volume ratio of 1:1 is filled and is left for three minutes so that positive electrode 3 is impregnated with the electrolyte solution. Then, gasket 6 is placed on sealing plate 1 to which negative electrode 2 is compressed, which is then fitted into case 5. Finally, an opening portion of case 5 is curled and case 5 is sealed. Thus, battery 10 of sample A having a diameter of 23 mm and thickness of 3 mm is completed.

The space volume in battery 10 of sample A is a remaining volume obtained by subtracting a volume occupied by the real volume of all constituting materials of battery 10 contained in case 5 from an entire space volume in battery 10 when case 5 is just sealed with sealing plate 1. In the case of a test battery, the entire battery space volume is 761 μl. Furthermore, the real volume of solids including positive electrode 3, negative electrode 2, and separator 4 is 369 μl. Space excluding the real volume of the solids is 392 μl.

When battery 10 is divided into the side of positive electrode 3 and the side of negative electrode 2, by plane 8 dividing separator 4 into two sections at the middle in the thickness direction, the space volume at the side of positive electrode 3 before an electrolyte solution is filled is 318 μl, and the space volume at the side of negative electrode 2 is 74 μl. These space volumes are calculated by subtracting the real volume of components from the actual volume in battery 10. The real volume of the components is measured from apparently increased amount of an electrolyte solution when the components are immersed into the electrolyte solution. As to positive electrode 3, raw material powders are immersed into an electrolyte solution without molding, and from the volume and weight, the real density is calculated. Thus, from the actual weight of positive electrode 3, the real volume is calculated.

For sample B, a test battery is produced by the same method as sample A except that the amount of the electrolyte solution is set to be 340 μl. For sample C, a test battery is produced by the same method sample A except that the amount of the electrolyte solution is set to be 360 μl.

For sample D, a test battery is produced by the same method as sample A except that the amount of the electrolyte solution is set to be 320 μl and sealing is carried out under the reduced pressure environment of 0.8 atmospheric pressures. For sample E, a test battery is produced by the same method as sample D except that the amount of the electrolyte solution is set to be 340 μl. For sample F, a test battery is produced by the same method as sample D except that the amount of the electrolyte solution is set to be 360 μl.

For sample G, a test battery is produced by the same method as sample A except that the amount of the electrolyte solution is set to be 320 μl and sealing is carried out under the environment of reduced pressure of 0.5 atmospheric pressures. For sample H, a test battery is produced by the same method as sample G except that the amount of the electrolyte solution is set to be 340 μl. For sample J, a test battery is produced by the same method as sample G except that the amount of the electrolyte solution is set to be 360 μl.

For comparison with these samples, samples K, L, and M are produced. Test batteries are produced by the same method as sample A except that the amount of the electrolyte solution is set to be 280 μl in sample K and 300 μl in sample L, and that sealing is carried out under atmospheric pressure in sample M. The pressure inside the test battery of sample M is calculated to be 1.1 as follows. A battery is produced and then the battery is disassembled in liquid paraffin so as to collect air in the battery. From the volume of the collected air and the space volume in the battery, pressure inside the test battery is calculated.

Battery 10 of each sample produced as mentioned above is firstly subjected to constant-resistance discharge with 15 kΩ at 25° C. up to 2.0 V, and the discharge capacity is measured. The discharge capacity in a state in which no centrifugal force is applied is defined to be 100%. In the case of this test battery, 265 mAh corresponds to 100% of discharge capacity.

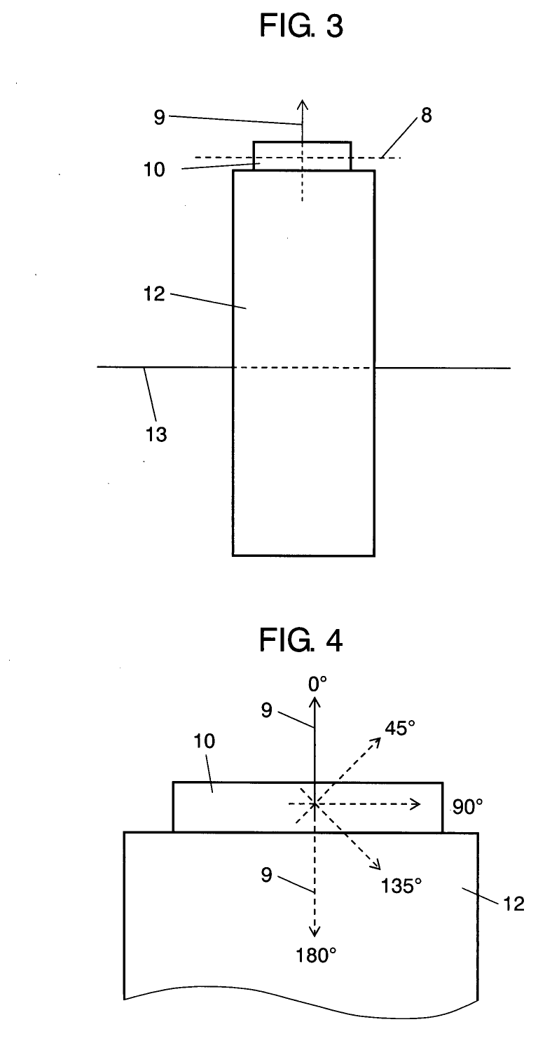

Next, as shown in FIGS. 2 and 3, battery 10 of each sample is placed on rotor 12 of a rotation tester and rotated around rotation axis 13 as a center, and the change of the discharge capacity by an angle at which battery 10 is placed with respect to the direction of the centrifugal force by rotation is measured. Considering variation between individual batteries 10, 320 of each of test batteries are produced, and 20 of batteries 10 for each test condition are evaluated so as to compare the averages.

The strength of centrifugal force is adjusted by the rotation of the rotation tester in a state in which a centrifugal force of 30 G, 100 G and 1000 G is applied, respectively. As to the angle at which the battery is attached, an angle is defined to be 0° when direction 9 of the central axis from the center of positive electrode 3 to the center of negative electrode 2 as shown in FIG. 1 coincides with the direction of a centrifugal force. That is to say, an angle is defined to be 0° when negative electrode 2 is located outside rotor 12 and normal line 9 has the same direction as that of the centrifugal force. As shown in FIG. 4, an angle is defined to be 180° in the reversed position where positive electrode 3 is located at the outside of rotor 12 and normal line 9 has the same direction as that of the centrifugal force. Then, rotor 12 is rotated in a state in which battery 10 is fixed at angles of 0°, 45°, 90°, 135°, and 180°. The results of the above-mentioned tests are shown in Tables 1, 2 and 3, respectively.

TABLE 1

| | Amount of | Pressure at | | | | | |
|---|---|---|---|---|---|---|---|
| | electrolytic | sealing time | Usage ratio of discharge | | | | |
| | solution | (atmospheric | capacity (%) | | | | |
| Sample | (μl) | pressure) | 0° | 45° | 90° | 135° | 180° |
| A | 320 | 1.0 | 100 | 100 | 99 | 99 | 99 |
| B | 340 | 1.0 | 100 | 100 | 100 | 100 | 100 |
| C | 360 | 1.0 | 100 | 100 | 100 | 100 | 100 |
| D | 320 | 0.8 | 100 | 100 | 100 | 100 | 100 |
| E | 340 | 0.8 | 100 | 100 | 100 | 100 | 100 |
| F | 360 | 0.8 | 100 | 100 | 100 | 100 | 100 |
| G | 320 | 0.5 | 100 | 100 | 100 | 100 | 100 |
| H | 340 | 0.5 | 100 | 100 | 100 | 100 | 100 |
| J | 360 | 0.5 | 100 | 100 | 100 | 100 | 100 |
| K | 280 | 1.0 | 100 | 99 | 95 | 91 | 90 |
| L | 300 | 1.0 | 100 | 100 | 99 | 99 | 98 |
| M | 320 | 1.1 | 100 | 100 | 99 | 99 | 99 |

TABLE 2

| | Amount of | Pressure at | | | | | |
|---|---|---|---|---|---|---|---|
| | electrolytic | sealing time | Usage ratio of discharge | | | | |
| | solution | (atmospheric | capacity (%) | | | | |
| Sample | (μl) | pressure) | 0° | 45° | 90° | 135° | 180° |
| A | 320 | 1.0 | 100 | 97 | 94 | 97 | 99 |
| B | 340 | 1.0 | 100 | 100 | 99 | 99 | 100 |
| C | 360 | 1.0 | 100 | 100 | 100 | 100 | 100 |
| D | 320 | 0.8 | 100 | 97 | 95 | 98 | 100 |
| E | 340 | 0.8 | 100 | 100 | 97 | 99 | 100 |
| F | 360 | 0.8 | 100 | 100 | 99 | 100 | 100 |
| G | 320 | 0.5 | 100 | 97 | 95 | 97 | 99 |
| H | 340 | 0.5 | 100 | 100 | 99 | 100 | 100 |
| J | 360 | 0.5 | 100 | 100 | 96 | 100 | 100 |
| K | 280 | 1.0 | 100 | 85 | 28 | 8 | 2 |
| L | 300 | 1.0 | 100 | 96 | 88 | 84 | 80 |
| M | 320 | 1.1 | 100 | 97 | 94 | 97 | 99 |

TABLE 3

| | Amount of | Pressure at | | | | | |
|---|---|---|---|---|---|---|---|
| | electrolytic | sealing time | Usage ratio of discharge | | | | |
| | solution | (atmospheric | capacity (%) | | | | |
| Sample | (μl) | pressure) | 0° | 45° | 90° | 135° | 180° |
| A | 320 | 1.0 | 100 | 97 | 93 | 94 | 97 |
| B | 340 | 1.0 | 100 | 98 | 96 | 98 | 100 |
| C | 360 | 1.0 | 100 | 100 | 99 | 100 | 100 |
| D | 320 | 0.8 | 100 | 97 | 93 | 94 | 97 |
| E | 340 | 0.8 | 100 | 99 | 96 | 99 | 100 |
| F | 360 | 0.8 | 100 | 100 | 97 | 99 | 100 |
| G | 320 | 0.5 | 100 | 96 | 92 | 93 | 98 |
| H | 340 | 0.5 | 100 | 99 | 96 | 98 | 100 |
| J | 360 | 0.5 | 100 | 100 | 98 | 99 | 100 |
| K | 280 | 1.0 | 100 | 72 | 11 | 3 | 0.2 |
| L | 300 | 1.0 | 100 | 94 | 81 | 72 | 40 |
| M | 320 | 1.1 | 100 | 97 | 93 | 94 | 97 |

All of the batteries of samples A to J and M show more excellent discharge capacity in an environment in which a centrifugal force is applied as compared with the batteries of samples K and L.

In the structure of a flat battery, when the angle at which the battery is attached is 90°, the portion located outer side of rotor 12 is not completely filled with an electrolyte solution in the interface between positive electrode 3 and negative electrode 2. Nevertheless, as shown in the results of Tables 1 to 3, discharge is hardly affected in samples A to J and M. Thus, it is shown that by designing a battery as in this exemplary embodiment, it is possible to obtain excellent discharge property regardless of angles at which the battery is attached to rotor 12.

When battery 10 is disassembled so as to observe separator 4 right after a centrifugal force is actually applied, separator 4 of each battery of samples A to J and M is wet with an electrolyte solution at any attaching angle and at any centrifugal force strength. On the other hand, in samples K and L, when the attaching angle is 180° and the centrifugal force is 1000 G, separator 4 is substantially dry. Thus, there is a difference in the amount of an electrolyte solution impregnated in separator 4. Furthermore, in each battery of samples A to J and M, even in the case where a centrifugal force is applied, it is estimated that the electrolyte solution is present in separator 4 and on the surfaces facing positive electrode 3 and negative electrode 2.

In samples B and C whose amount of an electrolyte solution is larger than that of sample A, regardless of the strength of centrifugal force or the angle at which the battery is attached, the discharge capacity is substantially the same as that when the battery is in a stationary state. This is estimated to be because the electrolyte solution is filled in the surfaces facing the positive electrode 3 and negative electrode 2 necessary to the reaction, even when a centrifugal force is applied.

Next, 20 batteries of each sample are stored at a high temperature, and leakproof properties are compared. Specifically, after the batteries are stored at 60° C. during various periods of time, the leakage states are confirmed. These test results are shown in Table 4.

TABLE 4

| | Amount of | Pressure at | Number of batteries showing | | | |
|---|---|---|---|---|---|---|
| | electrolytic | sealing time | leakage | | | |
| Sam- | solution | (atmospheric | 1 | 2 | 3 | 4 |
| ple | ((l) | pressure) | month | months | months | months |
| A | 320 | 1.0 | 0 | 0 | 0 | 0 |
| B | 340 | 1.0 | 0 | 0 | 0 | 0 |
| C | 360 | 1.0 | 0 | 0 | 0 | 0 |
| D | 320 | 0.8 | 0 | 0 | 0 | 0 |
| E | 340 | 0.8 | 0 | 0 | 0 | 0 |
| F | 360 | 0.8 | 0 | 0 | 0 | 0 |
| G | 320 | 0.5 | 0 | 0 | 0 | 0 |
| H | 340 | 0.5 | 0 | 0 | 0 | 0 |
| J | 360 | 0.5 | 0 | 0 | 0 | 0 |
| K | 280 | 1.0 | 0 | 0 | 0 | 0 |
| L | 300 | 1.0 | 0 | 0 | 0 | 0 |
| M | 320 | 1.1 | 1 | 3 | 10 | 20 |

The leakproof properties of a lithium battery in the normal usage temperature range in this experiment are not different from each other in batteries of samples A to L. On the other hand, in the battery of sample M, leakage is observed at the first month and the number of leakage is gradually increased. This shows that by setting the pressure inside the space formed by sealing plate 1 and case 5, that is, inside the sealed case of battery 10 to be not more than one atmospheric pressure, the leakproof property can be improved. Furthermore, it is thought that the reduction of the discharge capacity due to a centrifugal force applied to battery 10 occurs because an electrolyte solution, which is necessary for the surfaces facing positive electrode 3 and negative electrode 2 participating in a reaction at a discharge time, is not present sufficiently. This state is significantly generated in a flat battery in which positive electrode 3 and negative electrode 2 are disposed facing in parallel to each other.

In a cylindrical battery, a bobbin structure in which a positive electrode and a negative electrode are disposed concentrically or a spiral structure in which long-length positive and negative electrodes are wound with a separator sandwiched therebetween so as to form an electrode group, the electrolyte solution is not unevenly distributed in one side of the positive electrode or the negative electrode. Therefore, there is no significant relation between the direction of a centrifugal force and the discharge capacity in general.

It is preferable that design of this exemplary embodiment is employed for not only a manganese dioxide lithium battery mentioned above but also a flat battery having a configuration in which positive electrode 3 is formed by powder molded product and has voids therein, and negative electrode 2 includes metal that does not have space therein such as a graphite fluoride lithium battery. With such a design, discharge can be normally carried out even in a state in which a centrifugal force is applied.

Even in a state in which a centrifugal force is applied, the electrolyte solution does not instantly flow out of the surfaces facing positive electrode 3 and negative electrode 2. Therefore, even in batteries of samples K and L, about 30 G of centrifugal force hardly affect the discharge capacity. Furthermore, even in a state in which an acceleration of about 100 G is applied, right after the rotation starts, discharge can be carried out also in batteries of samples K and L. Thereafter, in accordance with the flow-out of the electrolyte solution, discharge cannot be carried out. This battery is recovered to a state capable of normally carrying out discharge after the battery becomes free from a centrifugal force.

In this way, when the amount of an electrolyte solution is made to be larger than a space volume at side of positive electrode 3 when space formed in battery 10 is divided by plane 8 dividing separator 4 into two sections at the middle in the thickness direction, even in the case where a centrifugal force is applied and attaching angle is not 0°, battery 10 showing a sufficient discharge capacity can be provided. Note here that the upper limit of the amount of the electrolyte solution is a volume satisfying entire battery space volume. However, realistically, when the amount of the electrolyte solution is remarkably large, the electrolyte solution and the like are decomposed due to the reaction in the battery so as to generate gas. Thus, the leakproof property is remarkably reduced. Therefore, in a curled sealing structure shown in FIG. 1, a performance as a battery is lowered. Considering such things, it is preferable that the amount of the electrolyte solution is practically up to about 70% of the entire space volume in the battery.

In most cases in which a battery is attached to equipment, the battery is attached directly to a circuit board. In design of the equipment, even if it is difficult to attach a battery with considering the direction of a centrifugal force, an excellent discharge performance can be exhibited without restriction on the equipment design by using battery 10 in this exemplary embodiment.

### INDUSTRIAL APPLICABILITY

In a flat battery in accordance with the present invention, by regulating the amount of an electrolyte solution in the battery placed on a device to which a centrifugal force is applied, a state in which the electrolyte solution is reduced with respect to the reaction surface on the negative electrode is dissolved. In a state in which a centrifugal force is applied, no matter how a battery is set, a battery can be operated normally. Therefore, the battery is useful for operating equipment placed in a state in which a centrifugal force is applied, for example, a device for measuring an air pressure, which is placed on a vehicle tire, and the like.

1. A flat battery comprising:
a positive electrode having voids therein;
a negative electrode composed of a metal including an alkali metal and disposed facing the positive electrode;
a separator interposed between the positive electrode and the negative electrode and electrically insulating the positive electrode from the negative electrode;
an electrolyte solution impregnated into the separator and interposed between the positive electrode and the negative electrode; and
a sealed case containing the positive electrode, the negative electrode, the separator, and the electrolyte solution,
wherein a volume of the electrolyte solution is larger than a space volume at a side of the positive electrode when space formed in the sealed case is divided by a plane dividing the separator into two sections at a middle in a thickness direction thereof.

2. The flat battery according to claim 1, wherein a pressure inside the sealed case is not more than one atmospheric pressure.
